(19) United States
(12) Patent Application Publication
(10) Pub. No.: US 2025/0370261 A1
(43) Pub. Date: Dec. 4, 2025

(54) OPTICAL DEVICE AND IMAGING METHOD THEREFOR

(71) Applicant: GUANGZHOU LUXVISIONS INNOVATION TECHNOLOGY LIMITED, Guangzhou City (CN)

(72) Inventors: Cheng-Te Tseng, Guangzhou City (CN); Chen-Fu Huang, Guangzhou City (CN)

(73) Assignee: GUANGZHOU LUXVISIONS INNOVATION TECHNOLOGY LIMITED, Guangzhou City (CN)

(21) Appl. No.: 19/010,821

(22) Filed: Jan. 6, 2025

(30) Foreign Application Priority Data
May 31, 2024 (CN) 202410704497.9

(51) Int. Cl. G02B 27/01; G02B 27/00; G02F 1/29

(52) U.S. Cl. CPC G02B 27/0172; G02B 27/0075; G02B 27/0093; G02B 27/0179; G02F 1/294; G02B 2027/0138; G02B 2027/014; G02B 2027/0185; G02B 2027/0187

(57) ABSTRACT

An optical device includes an image module, a focusing module, a waveguide sheet having an entrance pupil region and an imaging region, an eye-sensing module, and a processing module electrically connected to the previous four. The image module generates a projected light. An optical axis of the focusing module is aligned with that of the image module. The entrance pupil region faces the focusing module. The projected light passes through the focusing module to the entrance pupil region and forms a projected image having an imaging distance and including at least one image position having distance information in the imaging region. The eye-sensing module senses a center of sight corresponding to one image position. The processing module takes the image position as a first image position and controls, in accordance with the distance information, the focusing module to adjust the imaging distance. An imaging method therefor is also provided.

### CROSS-REFERENCE TO RELATED APPLICATION

This non-provisional application claims priority under 35 U.S.C. § 119(a) to patent application Ser. No. 202410704497.9 filed in China on May 31, 2024, the entire contents of which are hereby incorporated by reference.

### BACKGROUND

### Technical Field

The present disclosure relates to an optical device, and in particular, to an optical device with an adjustable projection focal length.

### Related Art

In recent years, due to the development of technologies such as display technologies, sensing technologies, and human-computer interaction, application fields of optical devices such as augmented reality glasses are gradually expanding, and augmented reality glasses can be applied to industries such as consumer entertainment, healthcare, and education.

Augmented reality can superimpose projected video information and an image seen by human eyes in real life, thereby providing a user with a visual effect and a human- computer interaction experience, and providing a richer entertainment and information experience. For example, when the augmented reality glasses are applied to a game, the user can interact with a virtual element provided by the image in a real environment.

In a case of increasing applicable scenarios, when the user wears the glasses, the comfort of the glasses, the stability and clarity of image presentation, and the like appear to be particularly important.

### SUMMARY

In view of this, the present disclosure provides an optical device including an image module, a focusing module, a waveguide sheet, an eye-sensing module, and a processing module. The image module includes an exit pupil region and a projection module, where the projection module generates a projected light toward the exit pupil region. An optical axis of the focusing module is aligned with an optical axis of the image module. The waveguide sheet has an entrance pupil region and an imaging region connected to each other, where the entrance pupil region faces the focusing module, the projected light passes through the focusing module from the exit pupil region to the entrance pupil region and forms a projected image in the imaging region, the projected image has an imaging distance and includes at least one image position, and each image position has distance information. The eye-sensing module is configured to sense a center of sight corresponding to one image position. The processing module is electrically connected to the image module, the focusing module, and the eye-sensing module, where the processing module takes the image position corresponding to the center of sight as a first image position, and controls, in accordance with the distance information of the first image position, the focusing module to adjust the imaging distance of the projected image.

In an embodiment, the focusing module includes a solid lens and an actuation module, and the processing module controls, in accordance with the distance information, the actuation module to actuate the solid lens to linearly displace in relation to the waveguide sheet to adjust the imaging distance of the projected image.

In an embodiment, the focusing module includes a liquid lens and a driving module, and the processing module controls, in accordance with the distance information, the driving module to drive the liquid lens to deform to adjust the imaging distance of the projected image.

In an embodiment, the eye-sensing module includes at least one light source and a sensor, each light source generates a sensing light, and the sensor receives a reflected light of the sensing light reflected from outside of the optical device and analyzes the reflected light to obtain the center of sight.

In an embodiment, the processing module further generates a processing signal in accordance with the image position corresponding to another center of sight, and the projection module generates another projected light in accordance with the processing signal. The optical device further includes a photographing module electrically connected to the processing module. The photographing module performs turning on, turning off, photographing, focusing, or a combination of the above actions in accordance with the processing signal.

In an embodiment, the optical device further includes a galvanometer arranged on an optical path of the image module.

In an embodiment, the optical device further includes a frame including a frame body and an endpiece connected to each other. The eye-sensing module is arranged on the frame body, and the entrance pupil region of the waveguide sheet is located on the endpiece.

The present disclosure further provides an imaging method for an optical device, including the following steps: generating a projected light; transmitting, by a waveguide sheet, the projected light to form a projected image, where the projected image has an imaging distance and includes at least one image position, and each image position has distance information; sensing a center of sight, where the center of sight includes a first center of sight, the first center of sight corresponds to a first image position, and the first image position is one image position of the projected image; and adjusting the imaging distance of the projected image in accordance with the distance information of the first image position.

In an embodiment, the step of adjusting the imaging distance of the projected image in accordance with the distance information of the first image position is actuating a solid lens to linearly displace in relation to the waveguide sheet.

In an embodiment, the step of adjusting the imaging distance of the projected image in accordance with the distance information of the first image position is driving a liquid lens to deform.

In an embodiment, the center of sight further includes a second center of sight, and the imaging method further includes: sensing the second center of sight, where the second center of sight corresponds to a second image position, and the second image position is another image position of the projected image; generating a processing signal in accordance with the second image position; and generating another projected light in accordance with the processing signal.

In an embodiment, the method further includes: generating the processing signal in response to sensing the interruption of the center of sight; and generating another projected light in accordance with the processing signal.

In an embodiment, the processing signal is a photographing signal, and the method further includes: performing photographing in accordance with the photographing signal by using a photographing module.

In an embodiment, the step of sensing a center of sight includes: generating a sensing light; receiving a reflected light of the sensing light; and analyzing the reflected light to obtain the center of sight.

It can be learned from the foregoing solutions that the beneficial effects of the present disclosure are as follows: the optical device of the present disclosure can display a projected image with distance information and adjust an imaging distance of the projected image in accordance with a position at which a sight of a user focuses on the projected image, thereby giving the user an optimal focal length for viewing, preventing dizziness, and providing the user with a more immersive experience. In addition, the optical device of the present disclosure can generate different effects in accordance with a center of sight of the user to be applied to augmented reality glasses.

### BRIEF DESCRIPTION OF THE DRAWINGS

FIG. 1 is a schematic three-dimensional diagram of an optical device according to an embodiment;

FIG. 2 is a cross-sectional view taken along a position marked 2-2 in the embodiment of FIG. 1;

FIG. 3 is a schematic diagram of an imaging distance of a projected image according to an embodiment;

FIG. 4 is a flowchart of an imaging method for an optical device according to an embodiment;

FIG. 5 is a schematic diagram of forming a projected image in an imaging region of an optical device according to an embodiment;

FIG. 6 is a schematic diagram of sensing a center of sight of a user by an eye-sensing module according to an embodiment;

FIG. 7 is a schematic three-dimensional diagram of an optical device according to another embodiment;

FIG. 8 is a three-dimensional exploded view of an image module and a focusing module according to an embodiment;

FIG. 9 is a schematic diagram of sensing a center of sight of a user by an eye-sensing module according to another embodiment;

FIG. 10 is a schematic diagram of a projected image generated by a projection module after receiving a processing signal according to an embodiment;

FIG. 11 is a schematic three-dimensional diagram of an optical device according to an embodiment, showing a projected image generated by a projection module;

FIG. 12 is a schematic three-dimensional diagram of an optical device according to an embodiment, showing another projected image generated by a projection module;

FIG. 13 is a front view of an optical device according to an embodiment;

FIG. 14 is a schematic diagram of showing a projected image in an imaging region of an optical device according to an embodiment; and

FIG. 15 is a functional block diagram of an optical device including a photographing module according to an embodiment.

### DETAILED DESCRIPTION

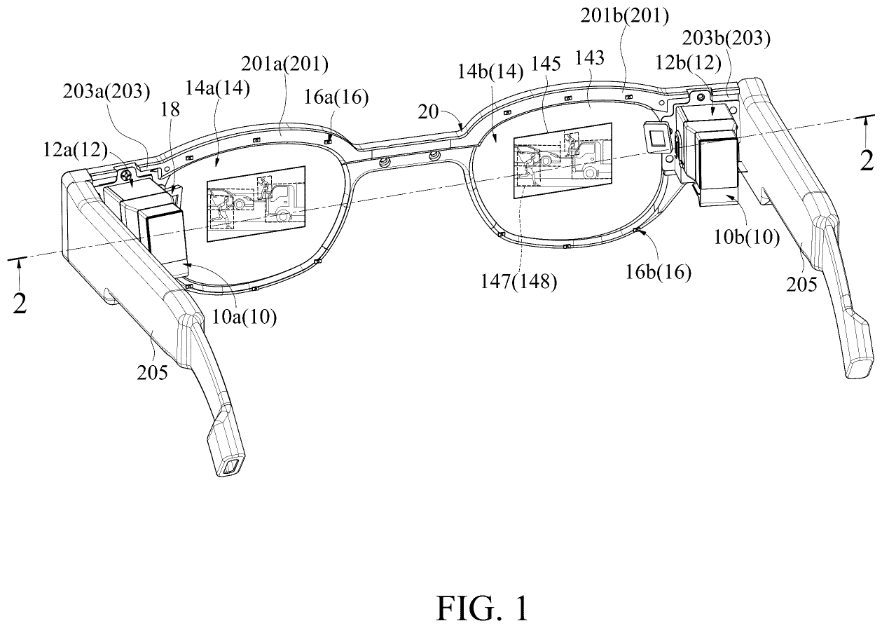

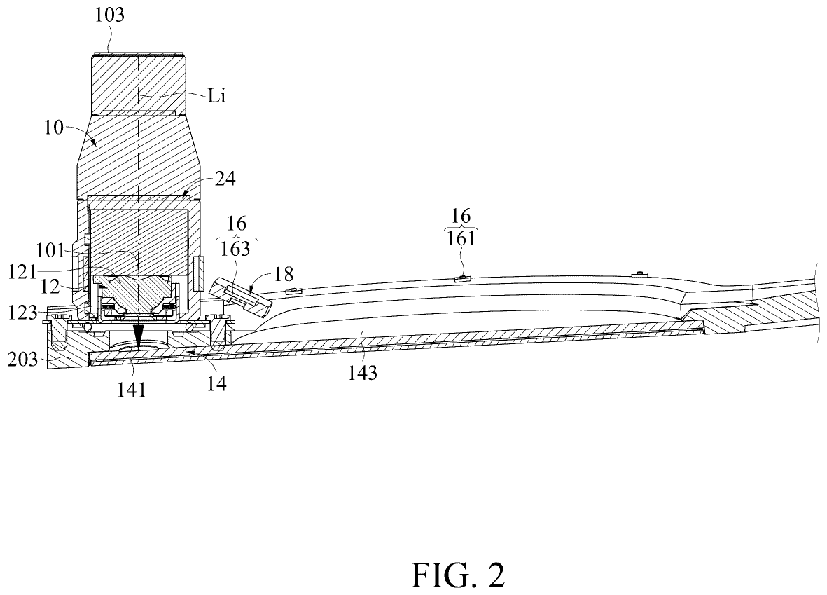

Refer to FIG. 1 and FIG. 2. FIG. 1 is a schematic three-dimensional diagram of an optical device according to an embodiment, and FIG. 2 is a cross-sectional view taken along a position marked 2-2 in the embodiment of FIG. 1. The optical device includes an image module 10, a focusing module 12, a waveguide sheet 14, an eye-sensing module 16, and a processing module 18. The image module 10 includes an exit pupil region 101 and a projection module 103. The projection module 103 generates a projected light Li and projects the projected light Li toward the exit pupil region 101. The focusing module 12 and the image module 10 each have an optical axis. The optical axis of the image module 10 is a projection center of the projection module 103, a center point of the exit pupil region 101 is aligned with the projection center of the projection module 103, and the optical axis of the focusing module 12 and the optical axis of the image module 10 are aligned with each other.

The waveguide sheet 14 has an entrance pupil region 141 and an imaging region 143 connected to each other. The entrance pupil region 141 faces the focusing module 12, and the projected light Li generated by the projection module 103 passes through the focusing module 12 from the exit pupil region 101 and is then coupled into the entrance pupil region 141 and transmitted to the imaging region 143 to form a projected image 145 in the imaging region 143. In some embodiments, when using the optical device, a user may observe the projected image 145 in the imaging region 143.

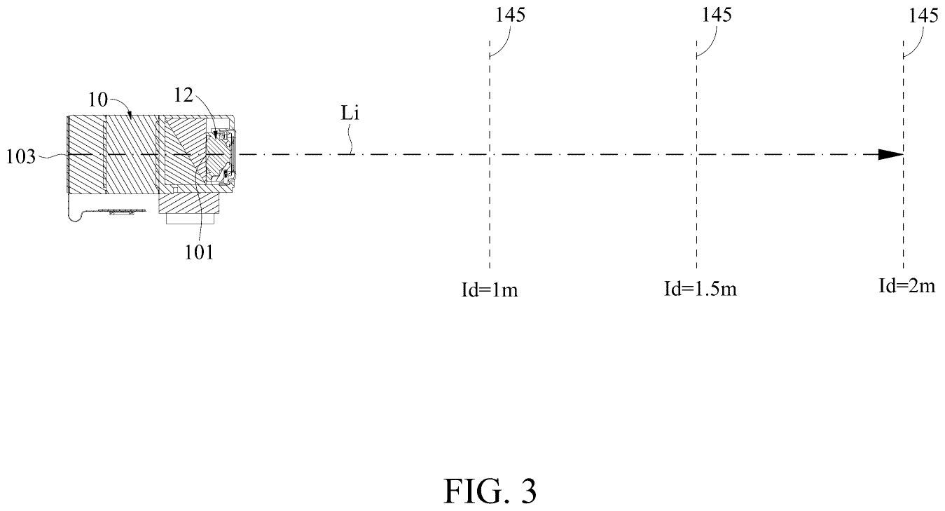

Refer to FIG. 2 and FIG. 3. FIG. 3 is a schematic diagram of an imaging distance of a projected image according to an embodiment. The projected image 145 has an imaging distance Id. The imaging distance Id is a position of a focal plane of the projected image 145 formed by the projection module 103 in the imaging region 143; that is, the projected image 145 can be clearly imaged at this distance. A position of the imaging distance Id may be changed by changing a position of a lens in the focusing module 12. For example, the imaging distance Id of the projected image 145 in FIG. 3 may be 1 m, 1.5 m, or 2 m.

Still referring to FIG. 1, the projected image 145 includes at least one image position 147, and each image position 147 has distance information. In some embodiments, an object or an environment may be photographed in a manner of emulating human eyes by using two or more cameras, and distances between the photographed object and the cameras are calculated by using focal lengths of the cameras, a distance between the cameras, and the like to obtain an image having distance information. If there are a plurality of objects in the image, the plurality of objects are respectively located at different positions in the image, and each position has corresponding distance information.

When the user uses the optical device, the eye-sensing module 16 is configured to sense a center of sight of an eye when the user views the projected image 145, and the center of sight corresponds to one image position 147 in the projected image 145. The processing module 18 is electrically connected to the image module 10, the focusing module 12, and the eye-sensing module 16. In some embodiments, the center of sight includes a first center of sight. After the eye-sensing module 16 senses the first center of sight, the processing module 18 takes the image position 147 corresponding to the first center of sight as a first image position 148, and controls, in accordance with the distance information of the first image position 148, the focusing module 12 to adjust a focal length to change the imaging distance Id of the projected image 145.

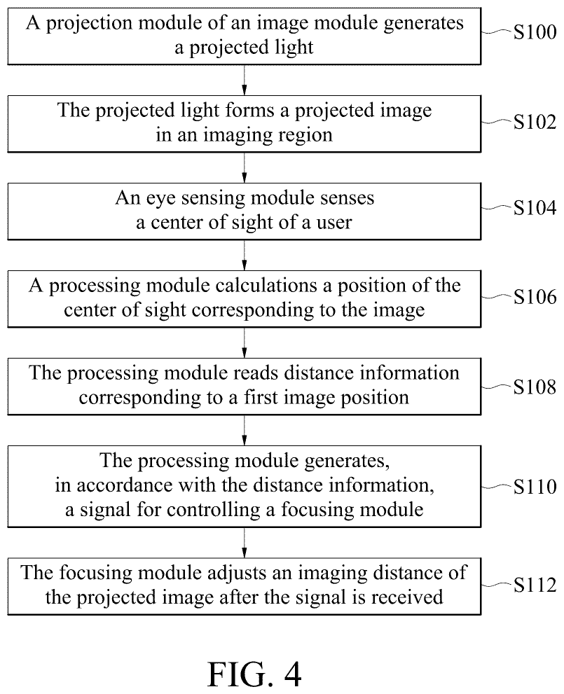

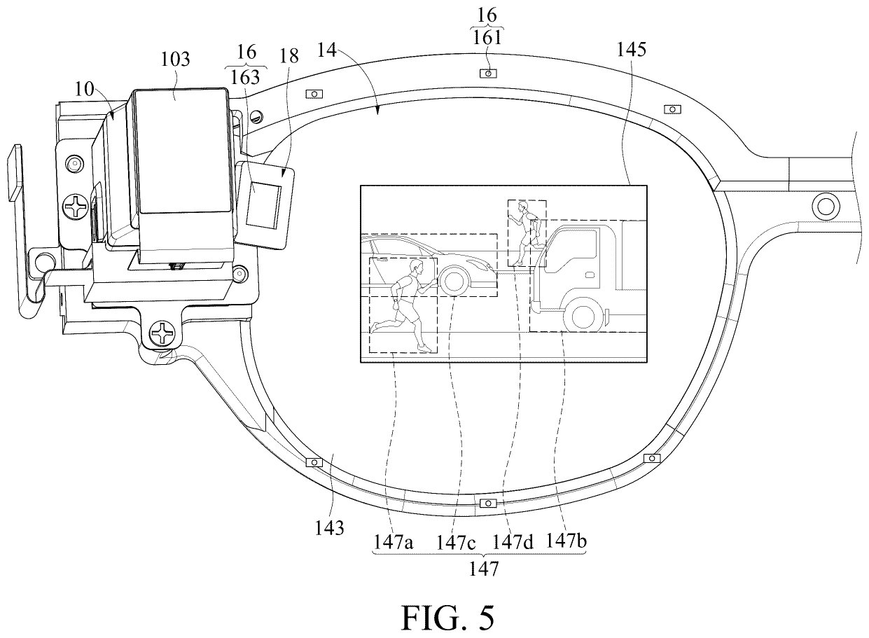

Refer to FIG. 2, FIG. 4, and FIG. 5 together. FIG. 4 is a flowchart of an imaging method for an optical device according to an embodiment, and FIG. 5 is a schematic diagram of forming a projected image in an imaging region of an optical device according to an embodiment. The projection module 103 of the image module 10 in the optical device generates the projected light Li (step S100). The projected light Li forms the projected image 145. The projection module 103 may generate the projected light Li of the image having the distance information captured by the foregoing two cameras. The foregoing manner of creating the image having the distance information is not limited to photographing by using two cameras and may alternatively be a different video or picture created through animation or in any manner. In addition, distance information at different positions in the image may be recorded in a manner such as an attached file.

The projected light Li passes through the focusing module 12 and enters the waveguide sheet 14. The entrance pupil region 141 of the waveguide sheet 14 may be a mirror, a prism, a relief grating, a volume holographic grating, or the like. The projected light Li is transmitted to the imaging region 143 in a manner of total reflection propagation to form the projected image 145 in the imaging region 143 (step S102). The imaging region 143 may be made of several sets of semi-transparent semi-reflective mirrors, relief gratings, volume holographic gratings, or the like. It can be seen from FIG. 5 that the projected image 145 is displayed in the imaging region 143 of the waveguide sheet 14. The projected image 145 has image positions 147a, 147b, 147c, and 147d. The image positions 147a, 147b, 147c, and 147d each have distance information, such as 0.5 m, 1 m, 3 m, and 4 m, respectively.

Still referring to FIG. 1, FIG. 2, and FIG. 4, in some embodiments, the optical device is in a form of glasses further including a frame 20. The frame 20 includes a frame body 201 and an endpiece 203 that are connected to each other. The eye-sensing module 16 is arranged on the frame body 201. The imaging region 143 of the waveguide sheet 14 is located on an inner side of the frame body 201. The entrance pupil region 141 of the waveguide sheet 14 is located on the endpiece 203. The endpiece 203 may be connected to a temple 205. When a user uses glasses and places the temple 205 on the car, the eye may correspond to a position of the imaging region 143 of the waveguide sheet 14, and then, after the projected image 145 is formed in the imaging region 143, the eye-sensing module 16 may sense a center of sight of the eye of the user (step S104).

In some embodiments, the frame 20 includes a left frame body 201a, a right frame body 201b, a left endpiece 203a, and a right endpiece 203b that are connected to each other. The optical device includes a left image module 10a, a left focusing module 12a, a left waveguide sheet 14a, and a left eye-sensing module 16a that are located on a left side of the frame 20, and a right image module 10b, a right focusing module 12b, a right waveguide sheet 14b, and a right eye-sensing module 16b that are located on a right side of the frame 20. The left eye-sensing module 16a is arranged on the left frame body 201a, the imaging region 143 of the left waveguide sheet 14a is located on an inner side of the left frame body 201a, the entrance pupil region 141 of the left waveguide sheet 14a is located on the left endpiece 203a, and the left endpiece 203a may be then connected to the temple 205. The left image module 10a and the left focusing module 12a are arranged at a position on the left endpiece 203a corresponding to the left waveguide sheet 14a. The right image module 10b and the like are arranged on the right endpiece 203b and/or the right frame body 201b in the same manner as the left image module 10a. Details are not described herein again. The left and right eyes of the user correspond to the positions of the imaging regions 143 of the left waveguide sheet 14a and the right waveguide sheet 14b, respectively. After the projected image 145 is formed in the imaging region 143, the left eye-sensing module 16a and the right eye-sensing module 16b can respectively sense the center of sights of the left and right eyes of the user.

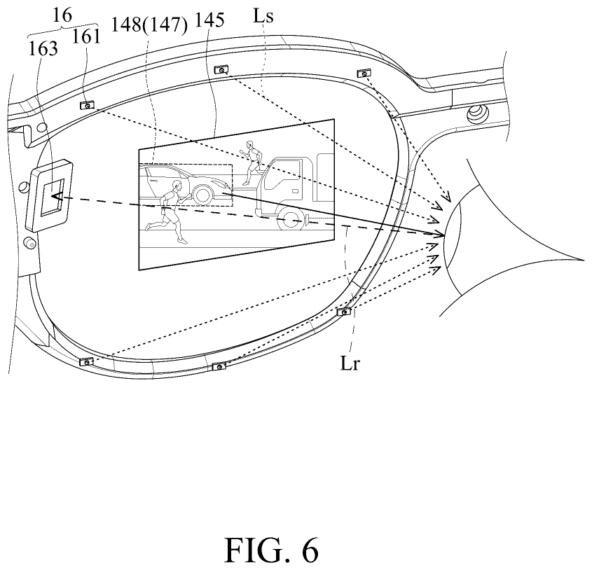

Refer to FIG. 4 and FIG. 6. FIG. 6 is a schematic diagram of sensing a center of sight of a user by an eye-sensing module according to an embodiment. In some embodiments, the eye-sensing module 16 includes a light source 161 and a sensor 163. A plurality of light sources 161 may be provided, and the light source 161 generates a sensing light Ls. When the user gazes at the first image position 148 in the projected image 145, an image light at the first image position 148 enters the eyes of the user. The sensing light Ls generated by the light source 161 is emitted toward the eyes of the user and may be reflected by the eyes. The sensor 163 receives a reflected light Lr of the sensing light Ls and analyzes the reflected light Lr to obtain the center of sight.

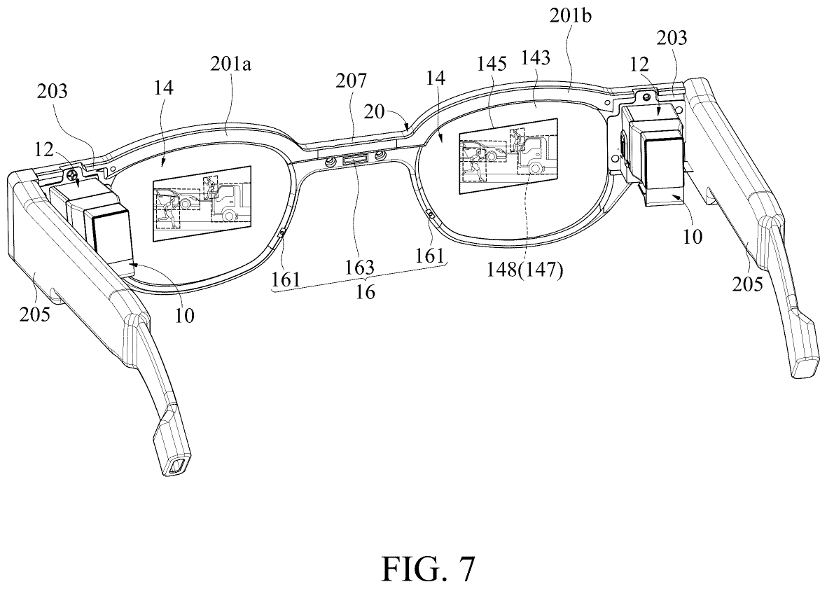

Refer. to FIG. 6 and FIG. 7. FIG. 7 is a schematic three-dimensional diagram of an optical device according to another embodiment. In some other embodiments, a bridge 207 is arranged between the left frame body 201a and the right frame body 201b. In these embodiments, the light source 161 of the eye-sensing module 16 is arranged on a position on the frame body 201 close to the bridge 207, and the sensor 163 is arranged on the bridge 207. In this way, one sensor 163 simultaneously receives the reflected light Lr of the sensing light Ls reflected by two eyes of the user. In the embodiments of FIG. 1 and FIG. 7, the light source 161 may be an infrared light-emitting diode, and the sensing light Ls generated by the light source 161 may be an infrared light.

In some embodiments, when analyzing the center of sight, the sensor 163 may determine a position of a pupil of the eye of the user in accordance with strength of the reflected light Lr to obtain the center of sight and transmit information about the reflected light Lr and the center of sight to the processing module 18.

Still referring to FIG. 3, FIG. 4, and FIG. 6, after receiving the position of the center of sight, the processing module 18 may calculate a position of the center of sight corresponding to the image in accordance with an angle of the reflected light Lr and the information about the center of sight and take the image position 147 as the first image position 148 (step S106). As described above, each image position 147 has distance information. The processing module 18 reads the distance information corresponding to the first image position 148 (step S108) and generates a signal for controlling the focusing module 12 (step S110). The focusing module 12 receives the signal from the processing module 18 and adjusts the imaging distance Id of the projected image 145 (step S112). In some embodiments, the processing module 18 may be a processing module 18 independent of the eye-sensing module 16. In other embodiments, the processing module 18 may alternatively be integrated in in the sensor 163 that is in the eye-sensing module 16 and for receiving and analyzing the center of sight (as shown in FIG. 1, the processing module 18 is integrated in the sensor 163 of the eye-sensing module 16).

Still referring to FIG. 2 and FIG. 3, in some embodiments, the focusing module 12 includes a solid lens 121 and an actuation module 123, and the imaging distance Id of the projected image 145 is adjusted through a linear displacement of the solid lens 121 relative to the waveguide sheet 14. For example, the distance information of the first image position 148 in FIG. 3 is 1 m. When the eyes of the user focus on the first image position 148, the eye-sensing module 16 senses the center of sight, and the processing module 18 analyzes the first image position 148 corresponding to the center of sight and obtains that the distance information of the first image position 148 is 1 m. The distance information of the image position 147 indicates that when the imaging distance Id of the projected image 145 is 1 m, the user can observe the clearest projected image 145 at the image position 147. Therefore, when the distance information of the first image position 148 is 1 m, the imaging distance Id of the projected image 145 is 1 m, so that the user can observe the clearest projected image 145 at the first image position 148. Therefore, the processing module 18 controls the actuation module 123 to actuate the solid lens 121 to linearly displace in relation to the waveguide sheet 14 until the imaging distance Id of the projected image 145 is 1 m, thereby giving the user an optimal focal length for viewing.

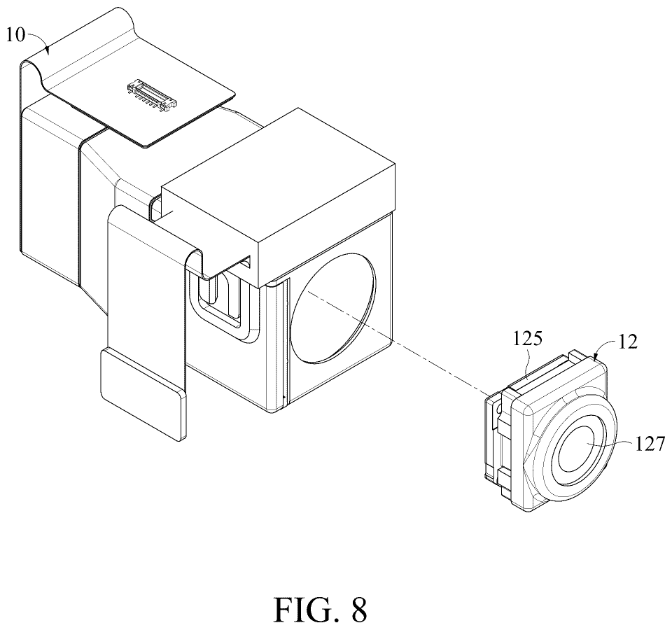

Refer to FIG. 8. FIG. 8 is a three-dimensional exploded view of an image module and a focusing module according to an embodiment. In another embodiment, the focusing module 12 includes a liquid lens 125 and a driving module 127. The liquid lens 125 may be implemented using two thin films with a liquid therebetween. The focal length of the liquid lens 125 is changed by changing shapes of the thin films by using the driving module 127. After obtaining the distance information of the first image position 148, the processing module 18 may control the driving module 127 to drive the liquid lens 125 to deform to adjust the imaging distance Id of the projected image 145, so that the imaging distance Id corresponds to the distance information of the first image position 148.

In some embodiments, the manner in which the actuation module 123 actuates the solid lens 121 and the driving module 127 drives the liquid lens 125 is not limited, and the actuation module 123 and the driving module 127 may be respectively implemented by using a voice coil motor (VCM), a piezo electric motor, a shape memory alloy (SMA) motor, or a micro-electro mechanical system (MEMS).

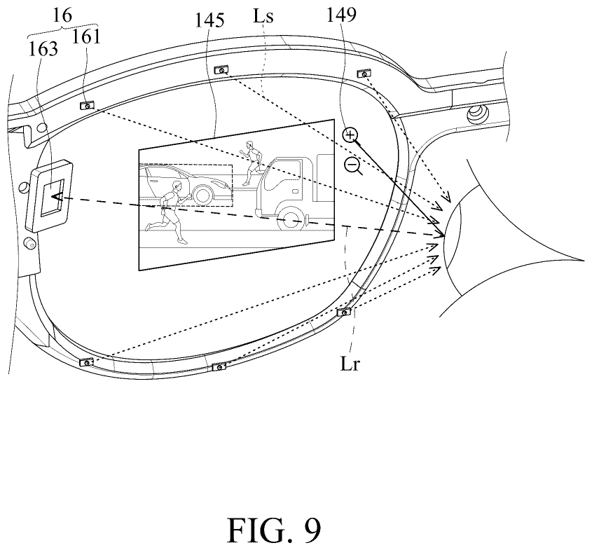

Still refer to FIG. 6 and FIG. 9. FIG. 9 is a schematic diagram of sensing a center of sight of a user by an eye-sensing module according to another embodiment. In some embodiments, the eye-sensing module 16 continuously senses the center of sight of the user. When the center of sight changes, the processing module 18 takes the image position 147 corresponding to another center of sight (hereinafter referred to as a second center of sight) after the change as a second image position 149. A position of the second image position 149 in the projected image 145 is different from that of the first image position 148. In this case, the processing module 18 generates the processing signal in accordance with the second image position 149. In some embodiments, after receiving the processing signal, the projection module 103 may generate another projected light Li, so that the projected image 145 of the imaging region 143 of the waveguide sheet 14 is changed.

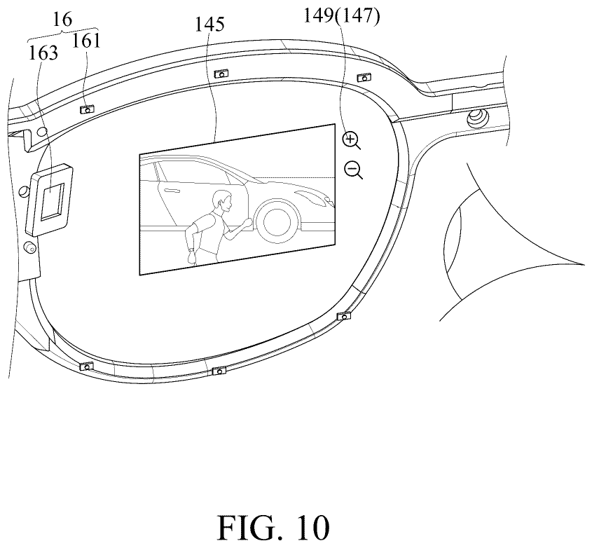

For example, when the first center of sight of the user corresponds to the first image position 148, the distance information of the first image position 148 is 1.5 m, and the processing module 18 controls the focusing module 12 to change the focal length to adjust the imaging distance Id of the projected image 145 to 1.5 m. Then, the eye-sensing module 16 senses that the center of sight of the user is changed from the first center of sight to the second center of sight (the center of sight is changed from the first image position 148 corresponding to the first center of sight shown in FIG. 6 to the second image position 149 corresponding to the second center of sight shown in FIG. 9), and the processing module 18 analyzes the second center of sight to obtain that the user currently gazes at the second image position 149. The processing module 18 generates the processing signal in accordance with the second image position 149, and after receiving the processing signal, the projection module 103 may generate another projected light Li to change the projected image 145 of the imaging region 143. In the embodiment of FIG. 9, the projected image 145 is displayed as a “magnified” icon at the second image position 149, and another projected image 146 formed by another projected light Li generated by the projection module 103 in accordance with the processing signal may have an effect of magnifying the original projected image 145 (as shown in the projected image 145 in FIG. 10).

Still referring to FIG. 6, in some other embodiments, the user may cause the processing module 18 to generate the processing signal by blinking or closing the eyes, and thus cause the projection module 103 to generate another projected light Li in accordance with the processing signal. Specifically, the eye-sensing module 16 continuously senses the center of sight of the user. When the user closes the eyes, the eyes of the user cannot reflect the sensing light Ls generated by the light source 161 to generate the reflected light Lr. Therefore, when the user closes the eyes, the sensor 163 does not receive the reflected light Lr after the sensing light Ls is reflected, and cannot obtain the current center of sight of the user. Then, the sensor 163 interrupts sensing of the center of sight, and the processing module 18 generates the processing signal. In some embodiments, the projection module 103 generates another projected light Li after receiving the processing signal.

In some embodiments, the sensor 163 may calculate a time during which the center of sight cannot be obtained and interrupt sensing of the center of sight when the time reaches a predetermined time. The predetermined time may range from 1 s to 2 s, and an average time for the user to blink during a normal physiological movement is about 250 milliseconds. This allows distinguishing whether the eye closing of the user is a blink during the normal physiological movement or a blink intended to cause the projection module 103 to generate another projected light Li.

In some embodiments, the sensor 163 may restart sensing of the center of sight after interrupting sensing of the center of sight for an interruption time. If the sensor 163 senses any center of sight, the processing module 18 may generate the processing signal to cause the projection module 103 to generate another projected light Li to form another projected image 145.

In some other embodiments, the sensor 163 may restart sensing of the center of sight after interrupting sensing of the center of sight for an interruption time. If the first center of sight corresponding to the first image position 148 is sensed, the processing module 18 adjusts the imaging distance Id of the projected image 145 in accordance with the distance information of the first image position 148. If the second center of sight corresponding to the second image position 149 is sensed, the processing module 18 may generate the processing signal to cause the projection module 103 to generate another projected light Li to form another projected image 146. If the sensor 163 cannot sense the center of sight of the user after restarting sensing of the center of sight, the sensor 163 may continuously sense until the center of sight is obtained again. In addition, it may be set that when the center of sight of the user cannot be sensed after the center of sight is restarted for a period of time, it indicates that the user has paused wearing the optical apparatus, and the processing module 18 generates the processing signal to turn off the optical device or put the optical device on standby.

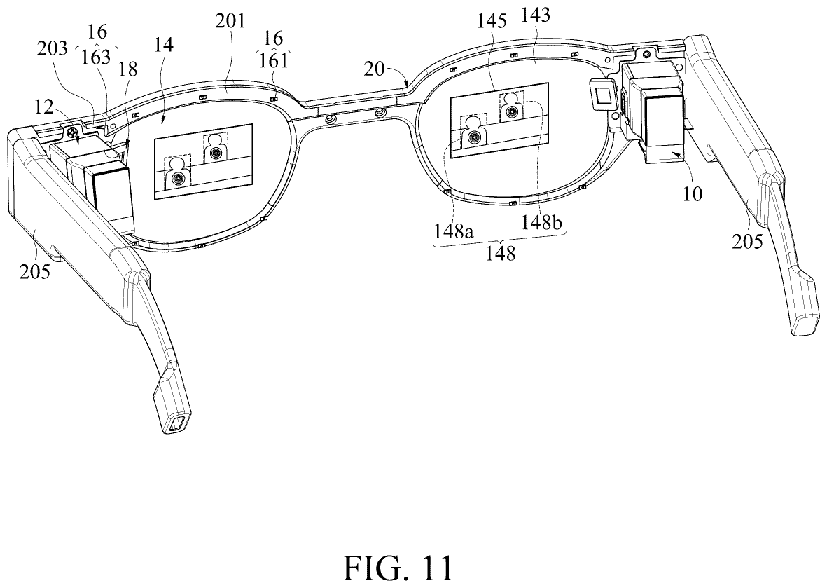

Refer to FIG. 11. FIG. 11 is a schematic three-dimensional diagram of an optical device according to an embodiment, showing a projected image generated by a projection module. In some other embodiments, as described above, the optical device includes the left waveguide sheet 14a and the left eye-sensing module 16a that are located on the left side of the frame 20 and may correspond to the left eye of the user, and the right waveguide sheet 14b and the right eye-sensing module 16b that are located on the right side of the frame 20 and may correspond to the right eye of the user. The processing module 18 may be electrically connected to the left eye-sensing module 16a, the right eye-sensing module 16b, the left projection module 103a, and the right projection module 103b simultaneously. When one eye-sensing module 16 (for example, the left eye-sensing module 16a) interrupts sensing of the center of sight because the eye (such as the left eye) of the user is closed, the processing module 18 generates the processing signal to cause the left projection module 103a to generate another projected light Li. Then the another eye-sensing module 16 (for example, the right eye-sensing module) continuously senses the center of sight of the other eye (for example, the right eye), and when the right eye-sensing module 16b senses the first center of sight corresponding to the first image position 148, the processing module 18 controls, in accordance with the distance information of the first image position 148, the right focusing module 12b to adjust the imaging distance Id of the projected image 145 formed by the projected light Li generated by the right projection module 103b. If the second center of sight corresponding to the second image position 149 is sensed, the processing module 18 may generate the processing signal to cause the right projection module 103 to generate another projected light Li.

The foregoing embodiment may be applied to an example in which a shooting game is run by using the optical device. The left projection module 103a and the right projection module 103b first generate the projected light Li together to form the projected image 145 of the shooting game in the imaging region 143 of the left waveguide sheet 14a and the imaging region 143 of the right waveguide sheet 14b, respectively. The projected image 145 may be displayed as icons of different shooting targets at the image positions 147 (as shown in FIG. 11).

Referring to FIG. 11, in some embodiments, the first image position 148 includes a first image position 148a and a first image position 148b, an icon displayed at the first image position 148a is used as a “shooting target 1” in the shooting game, an icon displayed at the first image position 148b is used as a “shooting target 2” in the shooting game, distance information of the first image position 148a is 1.5 m, and distance information of the first image position 148b is 2 m. In these embodiments, when the eye-sensing module 16 senses that the eyes of the user focus on the “shooting target 1”, it indicates that the eye-sensing module 16 senses a first center of sight corresponding to the first image position 148a, and the processing module 18 controls the focusing module 12 to adjust the imaging distance Id of the projected image 145 to 1.5 m in accordance with the distance information of the first image position 148a. Therefore, the user may observe the “shooting target 1” at the first image position 148a in the clear projected image 145.

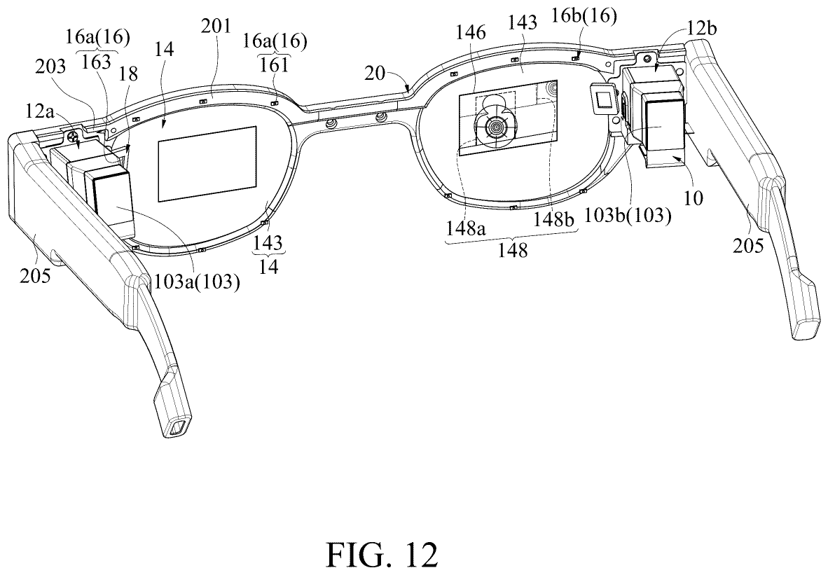

Refer. to FIG. 12. FIG. 12 is a schematic three-dimensional diagram of an optical device according to an embodiment, showing another projected image generated by a projection module. After the user closes one eye, for example, the left eye, after a predetermined time, a time during which the left eye-sensing module 16a cannot obtain the center of sight reaches the predetermined time and sensing of the center of sight is interrupted. The processing module 18 generates the processing signal, and the right projection module 103b generates another projected light Li after receiving the processing signal to form another projected image 146. Icons displayed in the another projected image 146 may be the locally magnified and clear “shooting target 1” and “a gunsight” (as shown in FIG. 12). In this case, because the left eye-sensing module 16a cannot obtain the center of sight, it may be considered that the left eye of the user is closed, and the left eye of the user cannot continuously observe the projected image 145 of the imaging region 143 of the left waveguide sheet 14a. Therefore, the left projection module 103a may temporarily stop generating the projected light Li until the left eye-sensing module 16a senses the center of sight again or continuously projects the projected image 145. As shown in FIG. 12, the left projection module 103a temporarily stops generating the projected light Li.

However, in the embodiment in which the sensor 163 of the left eye-sensing module 16a restarts sensing of the center of sight after interrupting sensing of the center of sight for an interruption time, and when the sensor 163 senses any center of sight, the processing module 18 generates the processing signal to cause the projection module 103 to generate another projected light Li, the left eye-sensing module 16a restarts sensing of the center of sight of the left eye after the interruption time. When the user opens the left eye, the sensor 163 senses the center of sight of the left eye. In this case, the processing module 18 generates the processing signal to cause the left projection module 103a and the right projection module 103b to simultaneously generate another projected light Li to form another projected image 145 (not shown in the figure), which may be “shooting the shooting target 1”.

In the embodiment in which one eye-sensing module 16 (for example, the left eye-sensing module 16a) interrupts sensing of the center of sight of the eye (for example, the left eye) because the eye of the user is closed, the processing module 18 generates the processing signal to cause the left projection module 103a and the right projection module 103b to simultaneously generate another projected light Li, and then the other eye-sensing module 16 (for example, the right eye-sensing module 16b) continuously senses the center of sight of the other eye (for example, the right eye), the right projection module 103b first generates another projected image 146 (as shown in FIG. 12) representing the locally magnified and clear “shooting target 1” and “a gunsight” after the left eye-sensing module 16a interrupts sensing. Then, when the right eye-sensing module 16b senses that the eyes of the user focus on the “shooting target 2” in another projected image 146, it indicates that the eye-sensing module 16 senses the first center of sight corresponding to the first image position 148b. The processing module 18 controls, in accordance with the distance information of the first image position 148b, the right focusing module 12b to adjust the imaging distance Id of the projected image 146 generated by the right projection module 103b to 2 m and locally magnifies the “shooting target 2”. Therefore, the user may observe, by the right eye, the locally magnified and clear “shooting target 2” in the clear projected image 146.

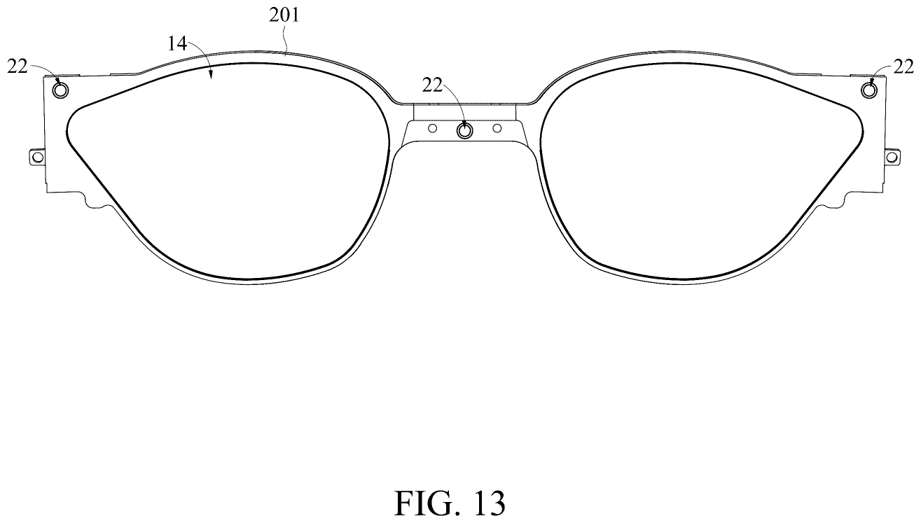

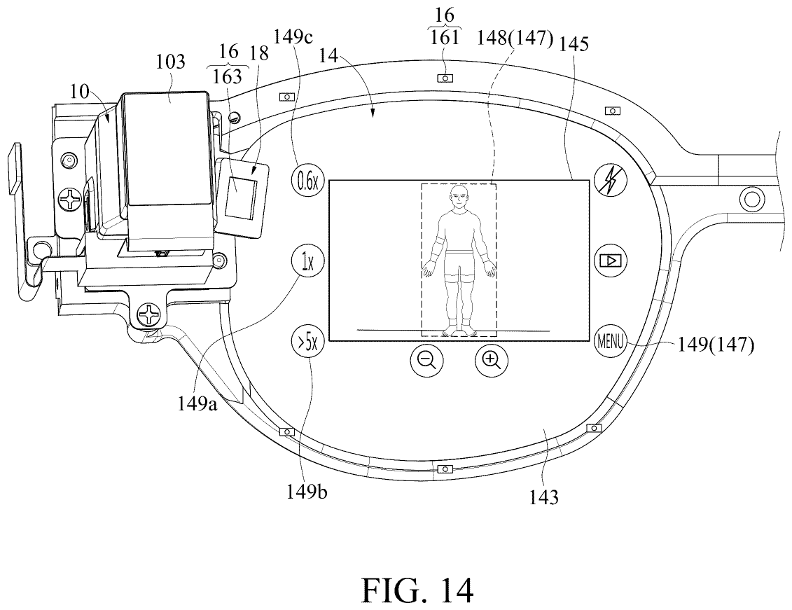

Refer to FIG. 13 and FIG. 14. FIG. 13 is a front view of an optical device according to an embodiment, and FIG. 14 is a schematic diagram of displaying a projected image in an imaging region of an optical device according to an embodiment. In some embodiments, the optical device includes a photographing module 22, and the photographing module 22 is electrically connected to the processing module 18. In accordance with the processing signal generated by the processing module 18 in accordance with the second image position 149 and the processing signal generated by the processing module 18 after the sensor 163 interrupts sensing of the center of sight, the photographing module 22 may be controlled to perform turning on, turning off, photographing, focusing, or a combination of the above actions. For example, when the eye-sensing module 16 senses the second center of sight corresponding to the second image position 149, the projected image 145 is displayed as an icon of “camera” at the second image position 149, and the processing signal generated by the processing module 18 in accordance with the second image position 149 may cause the photographing module 22 to be turned on.

In some embodiments, the photographing module 22 captures an image of an environment or an object, and the photographing module 22 transmits a signal of the captured image to the processing module 18, and the projection module 103 generates the projected light Li to form the projected image 145, which is displayed in the imaging region 143 of the waveguide sheet 14. The projected image 145 displayed in the imaging region 143 may be considered a preview image of the photographing module 22, so that the imaging region 143 displays in real time an image captured by the photographing module 22 for the user to view in real time.

In some embodiments, the processing signal generated by the processing module 18 is a photographing signal, and the photographing module 22 receives the photographing signal and then photographs the environment or the object in accordance with the photographing signal. Specifically, when the photographing module 22 is in an on state, the imaging region 143 of the waveguide sheet 14 displays the real-time image captured by the photographing module 22. In this case, if the eye-sensing module 16 cannot sense the center of sight (for example, when the user blinks) and interrupts sensing of the center of sight, the processing module 18 may generate a camera signal and transmit the camera signal to the photographing module 22. After receiving the camera signal, the photographing module 22 stores the received real-time image as a picture. In this way, when the photographing module 22 of the optical device is turned on, the user controls the photographing module 22 to take a picture in a manner of blinking or closing the eyes.

As shown in FIG. 13, in some embodiments, a plurality of photographing modules 22 are provided, and as described above, two or more cameras (that is, the photographing modules 22) are simultaneously used to photograph the object or the environment to obtain an image with distance information. Each of the photographing modules 22 transmits a captured image to the processing module 18, and the processing module 18 calculates a distance between the photographed object and the photographing module 22 in accordance with a focal length of the photographing module 22, a distance between the photographing modules 22, and the like to obtain the image having the distance information. This image is obtained through the projection module 103 generating the projected light Li and forming the projected image 145 in the imaging region 143 of the waveguide sheet 14.

The projected image 145 has the imaging distance Id, and the projected image 145 includes at least one image position 147. Each image position 147 has distance information. When the eye-sensing module 16 senses the first center of sight of the user corresponding to the first image position 148, the processing module 18 controls, in accordance with the distance information of the first image position 148, the focusing module 12 to adjust the focal length to change the imaging distance Id of the projected image 145. The projected image 145 may be considered a preview image of the photographing module 22, the image captured by the photographing module 22 is displayed in real time by using the imaging region 143 for the user to view in real time, and the focusing module 12 adjusts the focal length to change the imaging distance Id of the projected image 145 to achieve an effect equivalent to adjusting the focal length of the photographing module 22 to enable an object on which the sight of the user focuses to be clearly imaged. It should be noted that the effect is actually capturing and forming the projected image 145 including the distance information and adjusting the imaging distance Id of the projected image 145 to enable the user to obtain an optimal focal length for viewing.

In some embodiments, the eye-sensing module 16 continuously senses the center of sight, and the processing module 18 generates the processing signal when the second center of sight corresponding to the second image position 149 is sensed or when sensing is interrupted when the center of sight is not sensed. The processing signal may control the projection module 103 to generate another projected light and/or capture and store the projected image 145 currently presented in the imaging region 143 as a single picture. Another projected light generated by the projection module 103 may form the projected image 145 such as “prompt that photographing is completed” in the imaging region 143.

In some other embodiments, the processing signal may control the photographing module 22 to turn on or turn off a flash, enter an album, magnify or minify the projected image 145, and the like.

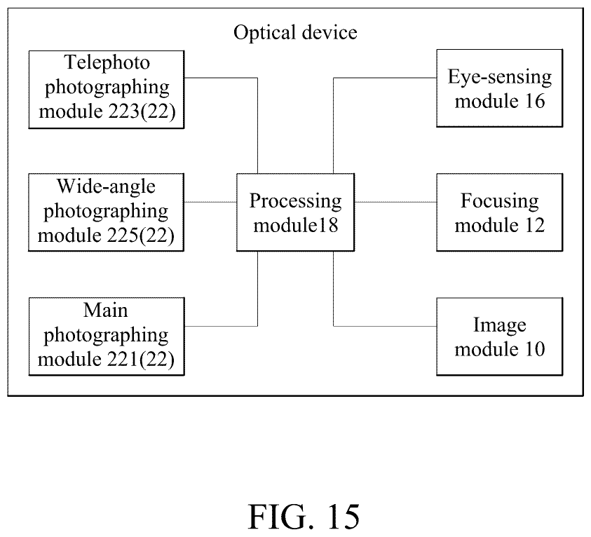

Refer to FIG. 13 and FIG. 15. FIG. 15 is a functional block diagram of an optical

device including a photographing module according to an embodiment. In some embodiments, a plurality of photographing modules 22 may be provided, and each of the photographing modules 22 has a different focal length range. For example, each of the photographing modules 22 is a main photographing module 221, a telephoto photographing module 223, or a wide-angle photographing module 225. In this way, when the user performs photographing by using the optical device, different photographing modules 22 may be switched to achieve photographing with a wider focal length range.

The main photographing module 221, the telephoto photographing module 223, and the wide-angle photographing module 225 are respectively connected to the processing module 18, and the plurality of photographing modules 22 may be switched in accordance with the processing signal generated by the processing module 18. Specifically, as shown in FIG. 14, the projected image 145 includes a plurality of second image positions 149, and an icon displayed at a second image position 149a is “1×”. When the eye-sensing module 16 senses that the second image position 149 corresponding to the second center of sight is the second image position 149a, the processing module 18 generates the processing signal to control the main photographing module 221 to be turned on, and the main photographing module 221 can capture an image with a normal field of view.

In addition, an icon displayed at a second image position 149b is “>5×”. When the eye-sensing module 16 senses that the second image position 149 corresponding to the second center of sight is the second image position 149b, the processing module 18 generates the processing signal to control the telephoto photographing module 223 to be turned on, and the telephoto photographing module 223 has a design of a 5× optical focal length to capture a long-distance image.

An icon displayed at a second image position 149c is “0.6×”. When the eye-sensing module 16 senses that the second image position 149 corresponding to the second center of sight is the second image position 149c, the processing module 18 generates the processing signal to control the wide-angle photographing module 225 to be turned on, and the wide-angle photographing module 225 can capture an image with a magnification of 0.6.

In some embodiments, the types of the photographing module 22 are not limited to the main photographing module 221, the telephoto photographing module 223, and the wide-angle photographing module 225, and focal length ranges of the main photographing module 221, the telephoto photographing module 223, and the wide-angle photographing module 225 are not limited.

Still referring to FIG. 2, in some embodiments, the optical device further includes a galvanometer 24. The galvanometer 24 may be arranged on an optical path on which the image module 10 generates the projected light Li, so that the projected image 145 formed in the imaging region 143 of the waveguide sheet 14 has a high resolution. The galvanometer 24 may be implemented by using XPR (extended pixel resolution).

In conclusion, the optical device of the present disclosure can display a projected image with distance information and adjust an imaging distance of the projected image in accordance with a position at which a sight of a user focuses on the projected image, thereby giving the user an optimal focal length for viewing, preventing dizziness, and providing the user with a more immersive experience. In addition, the optical device of the present disclosure can generate different effects in accordance with a center of sight of the user to be applied to augmented reality glasses.

The present disclosure has been described in detail above. The foregoing descriptions are merely exemplary embodiments of the present disclosure and are not intended to limit the scope of implementation of the present disclosure. To be specific, equivalent changes and modifications made within the scope of this application shall fall within the protection scope of the appended claims of this application.

What is claimed is:

1. An optical device, comprising:
an image module, comprising an exit pupil region and a projection module, wherein the projection module generates a projected light toward the exit pupil region;
a focusing module, wherein an optical axis of the focusing module is aligned with an optical axis of the image module;
a waveguide sheet, having an entrance pupil region and an imaging region connected to each other, wherein the entrance pupil region faces the focusing module, the projected light passes through the focusing module from the exit pupil region to the entrance pupil region and forms a projected image in the imaging region, the projected image has an imaging distance and comprises at least one image position, and each image position has distance information;
an eye-sensing module, configured to sense a center of sight corresponding to one image position; and
a processing module electrically connected to the image module, the focusing module, and the eye-sensing module, wherein the processing module takes the image position corresponding to the center of sight as a first image position, and controls, in accordance with the distance information of the first image position, the focusing module to adjust the imaging distance of the projected image.

2. The optical device according to claim 1, wherein the focusing module comprises a solid lens and an actuation module, and the processing module controls, in accordance with the distance information, the actuation module to actuate the solid lens to linearly displace in relation to the waveguide sheet to adjust the imaging distance of the projected image.

3. The optical device according to claim 1, wherein the focusing module comprises a liquid lens and a driving module, and the processing module controls, in accordance with the distance information, the driving module to drive the liquid lens to deform to adjust the imaging distance of the projected image.

4. The optical device according to claim 1, wherein the eye-sensing module comprises at least one light source and a sensor, each light source generates a sensing light, and the sensor receives a reflected light of the sensing light reflected from outside of the optical device and analyzes the reflected light to obtain the center of sight.

5. The optical device according to claim 1, wherein the processing module further generates a processing signal in accordance with the image position corresponding to another center of sight, and the projection module generates another projected light in accordance with the processing signal.

6. The optical device according to claim 5, further comprising a photographing module electrically connected to the processing module, wherein the photographing module performs turning on, turning off, photographing, focusing, or a combination of the above actions in accordance with the processing signal.

7. The optical device according to claim 1, further comprising a galvanometer arranged on an optical path of the image module.

8. The optical device according to claim 1, further comprising a frame comprising a frame body and an endpiece connected to each other, wherein the eye-sensing module is arranged on the frame body, and the entrance pupil region of the waveguide sheet is located on the endpiece.

9. An imaging method for an optical device, comprising:
generating a projected light;
transmitting, by a waveguide sheet, the projected light to form a projected image, wherein the projected image has an imaging distance and comprises at least one image position, and each image position has distance information;
sensing a center of sight, wherein the center of sight comprises a first center of sight, the first center of sight corresponds to a first image position, and the first image position is one image position of the projected image; and
adjusting the imaging distance of the projected image in accordance with the distance information of the first image position.

10. The imaging method for an optical device according to claim 9, wherein the step of adjusting the imaging distance of the projected image in accordance with the distance information of the first image position is actuating a solid lens to linearly displace in relation to the waveguide sheet.

11. The imaging method for an optical device according to claim 9, wherein the step of adjusting the imaging distance of the projected image in accordance with the distance information of the first image position is driving a liquid lens to deform.

12. The imaging method for an optical device according to claim 9, wherein the center of sight further comprises a second center of sight, and the imaging method further comprises:
sensing the second center of sight, wherein the second center of sight corresponds to a second image position, and the second image position is another image position of the projected image;
generating a processing signal in accordance with the second image position; and
generating another projected light in accordance with the processing signal.

13. The imaging method for an optical device according to claim 9, further comprising:
generating a processing signal in response to sensing interruption of the center of sight; and
generating another projected light in accordance with the processing signal.

14. The imaging method for an optical device according to claim 13, wherein the processing signal is a photographing signal, and the method further comprises performing photographing in accordance with the photographing signal by using a photographing module.

15. The imaging method for an optical device according to claim 9, wherein the step of sensing a center of sight comprises:
generating a sensing light;
receiving a reflected light of the sensing light; and
analyzing the reflected light to obtain the center of sight.
